(19) United States
(12) Patent Application Publication
(10) Pub. No.: US 2007/0212944 A1
(43) Pub. Date: Sep. 13, 2007

(54) COMBINED SATAT FEMALE CONNECTOR

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,283

(22) Filed: Jul. 21, 2006

(30) Foreign Application Priority Data
Mar. 9, 2006 (CN) 200610034226.9

(51) Int. Cl. H01R 24/00

(52) U.S. Cl. 439/660

(57) ABSTRACT

An electrical connector includes a main body and a cable integrally formed with the main body. The main body includes at least two connectors for connecting with at least two compatible connectors. The cable includes at least two electrical wires. Ends of the electrical wires are respectively electrically connected with the connectors of the main body.

### 1. FIELD OF THE INVENTION

The present invention relates to an electrical connector.

### 2. DESCRIPTION OF RELATED ART

FIG. 1 shows a motherboard 40 of a server with four conventional Serial Advanced Technology Attachment (SATA) male connectors 50 and four conventional SATA female connectors 60 for receiving the SATA male connectors 50. The four SATA male connectors 50 are located on the motherboard 40 and adjacent each other. Each of the female connectors 60 includes a socket 62 and an electrical wire 64 connected with the socket 62.

Referring also to FIG. 2, when it is desired that a server needs to be connected to some SATA peripheral devices such as SATA hard disks (not shown). The SATA hard disks will be connected to the server by connection of the SATA male connectors 50 to the SATA female connectors 60 by the sockets 62. However, the sockets 62 of the SATA female connectors 60 need to be inserted into the SATA male connectors 50 one by one, thereby the connecting operation between the SATA male connectors 50 and the SATA female connectors 60 is unduly laborious and time-consuming. The numerous electrical wires 64 also may baffle air ventilation thereby reducing heat-dissipation efficiency of the server.

What is desired, therefore, is to provide an electrical connector which can simultaneously connect to a plurality of compatible connectors.

### SUMMARY OF THE INVENTION

In one preferred embodiment, an electrical connector includes a main body and a cable integrally formed with the main body. The main body includes at least two connectors for connecting with at least two compatible connectors. The cable includes at least two electrical wires. Ends of the electrical wires are respectively electrically connected with the connectors of the main body.

Other advantages and novel features will become more apparent from the following detailed description when taken in conjunction with the accompanying drawings, in which:

### BRIEF DESCRIPTION OF THE DRAWINGS

FIG. 1 is an isometric view of four conventional SATA female connectors, and a motherboard with four conventional SATA male connectors;

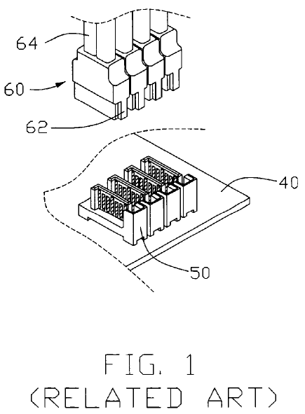

FIG. 2 is an isometric view of the SATA female connectors connected with the SATA male connectors of FIG. 1;

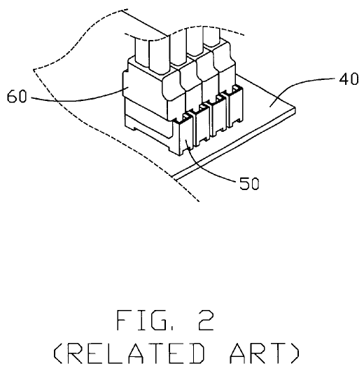

FIG. 3 is an isometric view of an electrical connector in accordance with a preferred embodiment of the present invention, the electrical connector including four female sockets together with a motherboard having four corresponding male connectors; and

FIG. 4 is an isometric view of the electrical connector connected with the male connectors of FIG. 3.

### DETAILED DESCRIPTION OF THE INVENTION

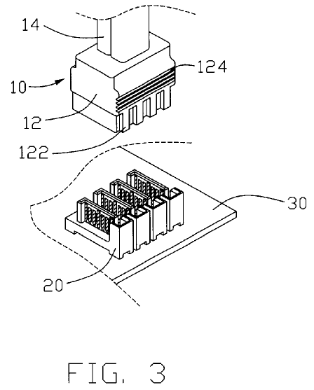

Referring to FIG. 3, an electrical connector 10 in accordance with a preferred embodiment of the present invention is provided to connect to at least two compatible connectors such as male connectors 20 mounted on a circuit board such as a motherboard 30. The male connectors 20 are adjacent each other. In this embodiment, an amount of the male connectors 20 is four and the male connectors 20 are Serial Advanced Technology Attachment (SATA) male connectors. The electrical connector 10 includes a main body 12 and a cable 14 integrally formed with the main body 12. The main body 12 includes four sockets 122 corresponding to the male connectors 20. Each socket 122 is integrally formed with its neighboring socket 122 and comprises a central hole to receive a central protrusion of the corresponding male connector 20. Conductors are formed at one same side of the central hole of the each socket 122 in order to electrically connect with conductors of the male connector 20 formed at a corresponding side of the central protrusion of the corresponding male connector 20. The cable 14 includes four electrical wires contained and protected by known means such as an insulating sheath. The four sockets 122 are respectively electrically connected with ends of the four electrical wires that are assembled in the cable 14. Other ends (not shown) of the electrical wires are for connecting with peripheral devices such as hard disks.

In this embodiment, the main body 12 of the electrical connector 10 includes a plurality of parallel grooves 124 defined in two opposite sidewalls thereof. The grooves 124 are to prevent an operator's fingers from slipping off the sidewalls of the main body 12 when manipulating the main body 12.

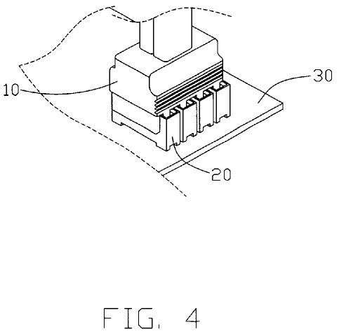

Referring also to FIG. 4, when it is desired to connect some peripheral devices such as hard disk drives (not shown) to the motherboard 30, a hard disk drive utilizing the present invention is selected. The electrical connector 10 is attached to the male connectors 20, which is very easy and convenient. Further, because the sockets 122 are connected with only one cable 14, airflow is less impeded.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

1. A combined Serial Advanced Technology Attachment (SATA) female connector comprising:
an integrated main body comprising at least two SATA female connectors configured for connecting to at least two SATA male connectors; and
a cable integrally formed with the main body, the cable comprising at least two electrical wires respectively electrically connected with the SATA female connectors of the main body.

2. The combined SATA female connector as claimed in claim 1, wherein the at least two electrical wires are contained and protected within the cable by an insulating sheath.

3. The combined SATA female connector as claimed in claim 1, wherein the main body comprises a plurality of grooves defined in two opposite sidewalls thereof for preventing an operator's fingers from slipping off the sidewalls of the main body.

4-5. (canceled)

6. An assembly comprising:
a circuit board comprising a plurality of Serial Advanced Technology Attachment (SATA) male connectors mounted thereon; and
a combined SATA female connector comprising a main body having a plurality of SATA female connectors extending from a side thereof, and a cable comprising a plurality of electrical wires extending from another side thereof, the cable integrally formed with the main body, one end of each of the plurality of electrical wires electrically connected to a corresponding one of the plurality of SATA female connectors of the combined SATA female connector, the SATA female connectors configured for electrically connecting to the SATA male connectors correspondingly.

7. The assembly as claimed in claim 6, wherein the main body comprises a plurality of grooves defined in two opposite sidewalls thereof for preventing an operator's fingers from slipping off the sidewalls of the main body.

8-9. (canceled)

10. The assembly as claimed in claim 6, wherein each of the plurality of SATA female connectors is integrally formed with a neighboring SATA female connector thereof, and a central hole is formed in the each of the plurality of SATA female connectors to receive a central protrusion of a corresponding one of the plurality of SATA male connectors.

11. The combined SATA female connector as claimed in claim 1, wherein each of the at least two SATA female connectors is integrally formed with a neighboring SATA female connector of the at least two SATA female connectors.

12. The combined SATA female connector as claimed in claim 1, wherein a central hole is formed in the each of the at least two SATA female connectors to receive a central protrusion of a corresponding one of the at least two SATA male connectors.

13. A Serial Advanced Technology Attachment (SATA) connector assembly comprising:
an Integrated main body comprising a plurality of SATA female sockets extending from a side of said main body, each of said plurality of SATA female sockets configured for connecting to a corresponding plurality of SATA male connectors, and being integrally formed with a neighboring one of said plurality of SATA female sockets; and
a cable integrally formed with the main body, and comprising a corresponding plurality of electrical wires respectively electrically connectable with said plurality of SATA female sockets.

14. The SATA connector assembly as claimed in claim 13, wherein each of said plurality of SATA female sockets comprises a central hole to receive a central protrusion of a corresponding one of said corresponding plurality of SATA male connectors, conductors are formed along a side of said central hole to electrically connect with corresponding conductors formed on said central protrusion.
